(19) United States
(12) Patent Application Publication
(10) Pub. No.: US 2004/0062903 A1
(43) Pub. Date: Apr. 1, 2004

(54) Floor covering with a reinforced foam backing

(76) Inventors: Paul D. Evans JR., Dalton, GA (US); Wallace J. Hammel, Chattanooga, TN (US); Brian S. Randall, Calhoun, GA (US)

Correspondence Address: WOMBLE CARLYLE SANDRIDGE & RICE, PLLC, P.O. BOX 7037, ATLANTA, GA, 30357-0037, US

(21) Appl. No.: 10/256,049

(22) Filed: Sep. 26, 2002

(51) Int. Cl. B32B 33/00; B32B 5/18; B32B 5/24

(52) U.S. Cl. 428/95; 442/30; 442/221

(57) ABSTRACT

A reinforced foam backing for a floor covering is presented. The reinforced foam backing comprises a foam layer comprising at least one thermoplastic polymeric material. The foam layer has a plurality of voids substantially uniformly distributed therein. The reinforced foam backing further comprises a reinforcing material adhered to the foam sheet.

### BACKGROUND OF THE INVENTION

The present invention relates generally to cushion-backed floor coverings and, more particularly, to a floor covering having a reinforced foam backing that may be made using a recycled and reclaimed waste polymeric material.

It is well-known in the floor covering industry to provide carpets and other floor coverings with a cushioned backing layer in the form of a closed cell foam material. These foam backing layers are generally formed from a flexible, resilient polymeric material having a large number of individual, non-connecting gas tight cells distributed throughout the material. The flexible polymer structure provides a cushioning effect by allowing the backing layer to compress under an external load and recover when the load is removed.

Foam backing layers may be constructed in a number of ways, but generally requires the formation of a sheet or layer of a suitable polymeric material mixed with a chemical blowing agent. Prior to curing of the sheet or layer, the chemical blowing agent is activated to form gas cells within the polymeric material. The expansion of the gas within these cells causes the sheet or layer to expand. The sheet or layer is then cured to establish a permanent resilient foam backing.

One problem that is often encountered in manufacturing cushioned floor coverings, however, is that handling of the pre-foamed sheet (e.g., passage of the sheet over rollers to change elevation or to transport the sheet to another processing area) can result in localized stretching and/or contracting of the uncured, unexpanded sheet. This can result in wrinkling and non-uniform expansion of the sheet when the sheet is heated to activate the blowing agent.

It is also well-known in the floor covering industry that recycling, reclaiming and reutilizing waste and scrap material, and particularly waste thermoplastic polymeric material is highly desirable. Processes for recycling floor coverings are particularly desirable inasmuch as a particularly large amount of scrap material is generated during the manufacture of floor covering. For example, in the manufacture of tufted carpet, the tufted carpet may have nylon pile secured in a primary backing of a woven polypropylene fabric, which has a secondary vinyl plastic backing. The pile, the primary backing and secondary backing are typically formed from thermoplastics having different characteristics.

The recycling of most mixtures of thermoplastic scrap material has been limited, however, by the incompatibility of the various different kinds of thermoplastic and non-thermoplastic material present in the scrap. For example, the various thermoplastic resins found in scrap carpet material are often insoluble in each other, which results in a heterogeneous mixture in which each type of resin forms a dispersed phase in the other. This often adversely affects the mechanical properties (e.g. tensile and impact strength) and aesthetic properties of any articles formed from such a mixture.

Several methods have been devised for recycling carpet materials, but these processes have not been entirely successful and have not found widespread usage because of economic infeasibility and limitations on the types of article that can be made from the recycled materials.

### SUMMARY OF THE INVENTION

Thus, it is among the objects of the invention to provide a method for manufacturing a reinforced foam backing for a floor covering.

It is another object of the invention that the reinforced foam backing be usable on both carpet tiles and roll goods of either woven or tufted construction of varying widths.

It is still another object of the invention to provide a method of manufacturing the reinforced foam backing using recycled and reclaimed scrap polymeric material.

An illustrative embodiment of the invention provides a reinforced foam backing for a floor covering. The reinforced foam backing comprises a foam layer comprising at least one thermoplastic polymeric material. The foam layer has a plurality of voids substantially uniformly distributed therein. The reinforced foam backing further comprises a reinforcing material adhered to the foam sheet.

Another embodiment of the invention provides a reinforced foam backing for a floor covering. The reinforced foam backing comprises a foam layer comprising a waste polymeric material including at least one non-fibrous thermoplastic material and from about 0 to about 40 percent aliphatic polyamide material. The foam layer has a plurality of gas-tight cells substantially uniformly distributed therein. The reinforced foam backing further comprises a reinforcing material adhered to the foam sheet.

A method of manufacturing a reinforced foam backing for a floor covering according to an embodiment of the invention comprises forming a polymeric material mixture comprising at least one thermoplastic polymeric material and a void-forming material. The polymeric material mixture is heated to melt the at least one thermoplastic polymeric material. The method further comprises forming a first intermediate sheet from the heated polymeric material mixture and forming a reinforced sheet comprising the first intermediate sheet and a reinforcing material attached to the first intermediate sheet. The method also comprises heating the reinforced sheet to activate the void-forming material to cause the reinforced sheet to expand to form the reinforced foam backing.

Another method of manufacturing a reinforced foam backing according to an embodiment of the invention comprises granulating a mixture of waste polymeric material including at least one non-fibrous thermoplastic material and from about 0 to about 40 percent aliphatic polyamide material to produce a granulated waste polymeric material mixture. A blowing agent having a predetermined decomposition temperature is added to the mixture of waste polymeric material to form a blowing agent and waste polymeric material mixture. The method further comprises forming a reinforced sheet comprising a first intermediate waste polymeric material sheet formed from the blowing agent and waste polymeric material mixture and a reinforcing material adhered to the first intermediate waste polymeric material sheet. The reinforced sheet is heated to a temperature above the decomposition temperature of the blowing agent, thereby causing the reinforced sheet to expand to form the reinforced foam backing.

Other objects and advantages of the invention will be apparent to one of ordinary skill in the art upon reviewing the detailed description of the invention.

### BRIEF DESCRIPTION OF THE DRAWINGS

FIG. 1 is a cross-sectional view of a prior art foam-backed tufted carpet;

FIG. 2 is a cross-sectional view of a prior art foam-backed woven carpet;

FIG. 3 is a diagrammatic representation of a processing line for manufacturing reinforced foam backing products in accordance with embodiments of the invention;

FIG. 4 is a diagrammatic representation of a calender unit that may be used in the processing line of FIG. 3;

FIG. 5A is a partial perspective view of a reinforced calendered sheet that is an intermediate product of a process according to an embodiment of the invention;

FIG. 5b is a cross-sectional view of a portion of the reinforced calendered sheet of FIG. 5A;

FIG. 6 is a cross-sectional view of a cushioned floor covering according to an embodiment of the invention;

FIG. 7 is a diagrammatic representation of a calender unit that may be used in a processing line for manufacturing reinforced foam backing products in accordance with embodiments of the invention;

FIG. 8 is a cross-sectional view of a cushioned floor covering according to an embodiment of the invention;

FIG. 9 is a cross-sectional view of a cushioned floor covering according to an embodiment of the invention;

FIG. 10 is a diagrammatic representation of a calender unit that may be used in a processing line for manufacturing reinforced foam backing products in accordance with embodiments of the invention;

FIG. 11 is a diagrammatic representation of a processing line for manufacturing reinforced foam backing products in accordance with embodiments of the invention; and

FIG. 12 is a cross-sectional view of a cushioned floor covering according to an embodiment of the invention.

### Detailed Description of the Invention

The invention provides a series of processes for manufacturing reinforced cushioned backing layers. The methods are adapted so the materials used to manufacture these backing layers are reinforced during the manufacturing process in order to maintain dimensional stability through out the expansion and curing portions of the process. The methods may also be adapted to use waste polymeric materials and, more particularly, waste carpet materials in the formation of the cushioned backing layers.

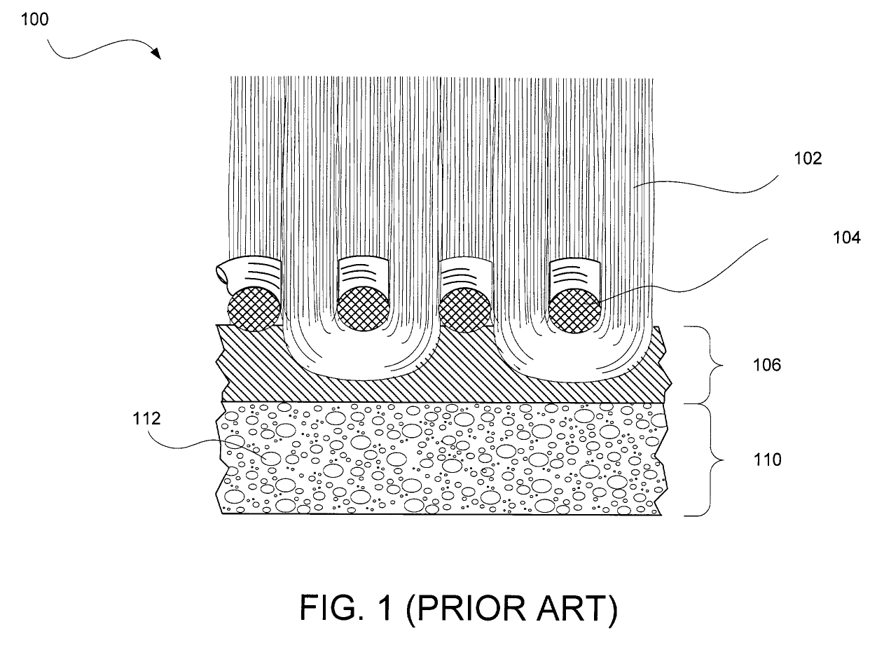

The backing layers of the invention may be used in conjunction with any floor covering but are particularly suited to use with carpets. Carpets to which cushion backing layers have been adhered include both tufted and woven varieties. With reference to FIG. 1, a cushion-backed tufted carpet 100 typically comprises tufted pile yarns 102 that are looped through a primary backing 104. An adhesive pre-coat layer 106 is used to fix the pile yarns 102 in place in the primary backing 104. A foamed secondary backing 110 is adhered to the pre-coat layer 106. The secondary backing 110 may be adhered by heat lamination using the pre-coat layer 106 or by using an additional another adhesive.

The primary backing 104 may be formed by weaving synthetic fibers, such as polypropylene, polyethylene, nylon, or polyester, for example, or may be a nonwoven construction utilizing one or more of these thermoplastic polymers. As is conventional, the pile yams 102 may be cut to form cut pile tufts as illustrated in FIG. 1 or may be left in uncut loops.

The pre-coat layer or backcoating 106 may comprise any suitable polymer compound. Typically, the pre-coat layer 106 is comprised of either a polymer emulsion polymerization product or a polymer plastisol compound. The pre-coat layer 106 is cured on the textile material by heating or drying or in any way that allows the pre-coat layer to cure, cross link or fuse to the textile material. An exemplary emulsion polymerization product includes a polyvinylidene chloride or ethylene vinyl copolymer. Alternatively, the pre-coat layer 106 may comprise conventional thermoplastic polymers that may be applied to the carpet by hot melt coating techniques known in the art.

The foamed secondary backing 110 is formed so as to provide a cushioning layer for the carpet. This is preferably accomplished by forming the backing 110 with a large number of voids or air spaces 112. Although a cushion structure may be formed from an open cell structure where the voids 112 are interconnected, it is preferred that at least some of the voids 112 are individual, non-connecting, gas tight cells, commonly referred to as closed cells. In general, the greater the percentage of closed cells in the structure, the better the cushioning properties of the backing layer. A structure having a significant majority of closed cell voids is generally referred to as a closed cell foam. Whether formed as an open cell structure, a partially closed cell structure or a closed cell foam, the backing 110 is preferably formed as a flexible polymer matrix. The resulting structure provides a cushioning effect by allowing the carpet backing to compress under an external load and recover when the load is removed.

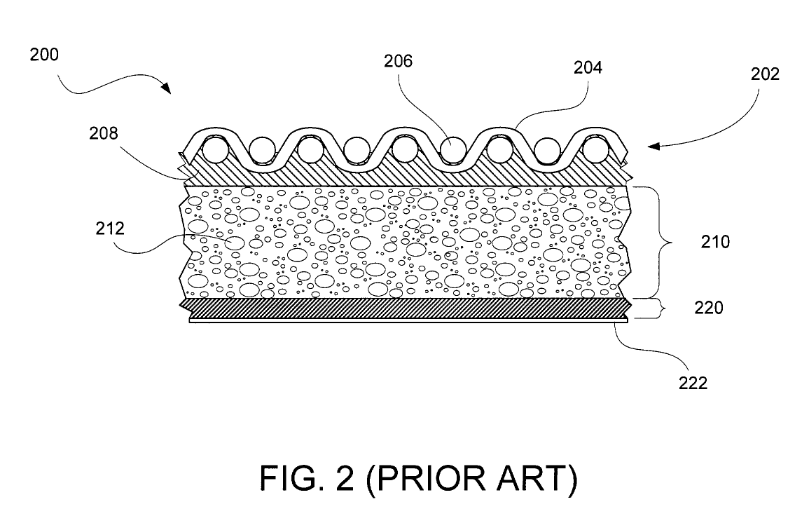

FIG. 2 illustrates a cushion-backed woven floor covering 200 having a woven carpet layer 202, a back-coating or resin composition layer 208, a foam backing layer 210 having voids 212 formed therein, and optionally, a pressure self-release adhesive layer 220 with a releasable cover 222. The woven carpet layer 202 is formed by weaving warp yarns 204 and weft yarns 206 to provide a decorative face surface.

The foam backing layer 210 is similar or identical to that described above for the tufted carpet. The cushioned woven floor covering 200 may be a rolled carpet or cut in the shape of a tile.

The foam backing layers 110, 210 may be formed from a polymeric composition having a blowing agent dispersed therein. The polymeric composition is used to form a sheet, which is then heated to activate the blowing agent, which causes the sheet to expand through the formation of the closed cells 112, thus forming the foam backing layer.

There are several methods by which the pre-foamed polymeric sheet may be formed. One method that is often used involves the application of a polymer/blowing agent plastisol mixture to a release belt, which is then passed beneath a doctor blade to form a sheet of material, which can then be heated to activate the blowing agent and cure the polymer. Other methods involve the use of calendering or extrusion to form the sheet.

These methods can suffer from dimensional stability problems if the uncured, unexpanded sheet must be handled to any significant degree prior to expansion and cure. Passage over rollers to change elevation or to transport the sheet to another processing area can result in the uncured sheet being stretched and contracted, which can produce local stress concentrations in the material. This, in turn, can result in wrinkling and non-uniform expansion of the sheet when the sheet is heated to activate the blowing agent.

The invention provides processes for manufacturing foam backing layers that involves the reinforcement of the unexpanded, uncured sheets from which the backing layers are formed. This reinforcement not only improves the dimensional uniformity of the backing layer, it helps to stabilize the floor covering product to which the backing layer is applied. The reinforced foam backing layers of the invention may be applied to either of the two types of floor covering described above and can be used in either rolled carpet goods or carpet tiles.

The reinforced floor coverings of the invention may also have cost advantages over other reinforced floor covering products. Previous reinforced vinyl-backed carpets, for example, have typically required the application of additional vinyl layers to the back of the carpet's polymer pre-coat in order to apply a scrim material or other reinforcing material layer. (See, e.g., the processes described in U.S. Pat. No. 6,406,574, which is incorporated herein by reference in its entirety.) The additional vinyl layers add significant expense to the product and require significant additions to the processing line. In substantial contrast, the reinforced floor coverings of the present invention do not require additional materials to incorporate the reinforcing material. Further, the processes of the present invention require only minimal changes to existing processing lines.

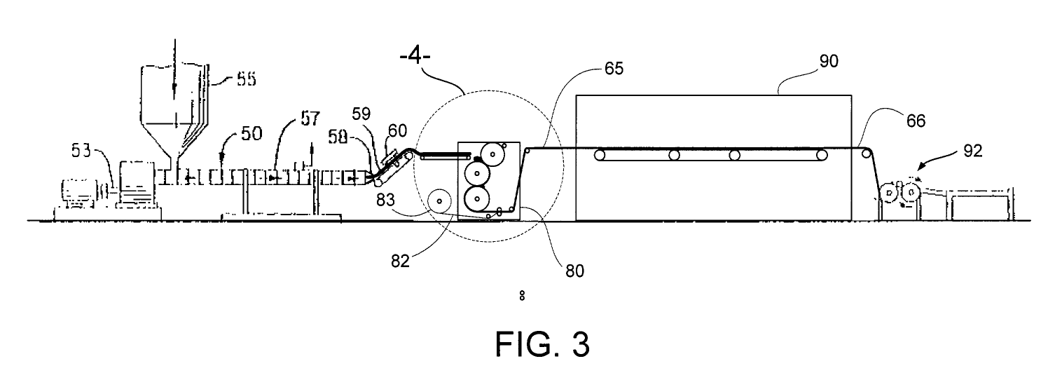

With reference to FIG. 3, a method of manufacturing a reinforced foam backing for a floor covering includes providing in a hopper 50 a mixture of polymeric materials. These polymeric materials may include one or more of a wide variety of thermoplastic materials such as polyolefins (e.g., polyethylene and polypropylene), polymers based on vinyl monomers (e.g., vinyl chloride and vinyl esters such as vinyl acetate), polymers based on acrylic monomers (e.g., acrylic acid, methyl acrylic acid, esters of these acids, and acrylonitrile), other thermoplastic polymers, and blends and copolymers thereof. A variety of fibrous polymeric materials may also be included in the mixture. Additional materials typically included in carpet backing layers may be added to the polymeric material mixture. These materials may include any of various plasticizers, inorganic fillers (e.g., calcium carbonate and barium sulfate), inorganic flame retardants (e.g., metal salts such as ATH and Mg(OH)₂, zinc borate, AOM and antimony trioxide), organic flame retardants (e.g., decabromodiphenyl oxide), fiberglass, pigments such as carbon black, stabilizers (e.g., zinc carboxylates and ESO), oils and processing aids.

The above mixture of polymeric materials and any additional additives are thoroughly mixed with a chemical blowing agent or other void producing material. The chemical blowing agent may be added in liquid, powder or pellet form. Particularly satisfactory blowing agents include heat-activated azodicarbonamide (azo) products such as Blo-Foam PMA 50 pellets produced by Rit Chem Company, Inc. The PMA 50 pellet includes about 50% azo blowing agent (ADC 1200 grade) and 50% PVC and is therefore 50% active. The average particle size (i.e., the average diameter of the circular particle) is preferably in a range 3-11 microns. Typical addition levels range from about 0.1 to about 5% (wt/wt) based on the percent “active” azodicarbonamide. The addition level is preferably in a range of about 0.5 to about 2.0% (about 0.25 to about 1.0% active).

The decomposition temperature of the active azo ingredient, ADC 1200, is approximately 195° C. to 220° C. (383° F. to 428° F.). However, the effective decomposition temperature of the activated azodicarbonamide of the pellet ranges from about 175° C. to 185° C. (347° F. to 365° F.). Other blowing agents having decomposition temperatures as low as about 163° C. (325° F.) may be used as long as the temperature during processing can be kept below the decomposition temperature.

The gas volume resulting from decomposition of azodicarbonamide is in the range of 85 to 115 ml/gram of azodicarbonamide. When the blowing agent is heated to its decomposition temperature, it decomposes (i.e., is activated) and produces a number of gases including nitrogen, carbon monoxide, carbon dioxide and ammonia. These gases expand and produce cells or gas pockets in the material. When the material hardens, permanent bubbles, cavities or voids are established.

Other chemical blowing agents that may be used in the invention include, but are not limited to, p-toluene sulfonyl semicarbizide or p,p oxybis benzene sulfonyl hydrazide (OBSH). The activation or decomposition rate of any of these blowing agents can be altered through the use of an activator. Suitable activators for azodicarbonamide blowing agents include, but are not limited to, transition metal salts, particularly those of lead, cadmium and zinc or organometallic compounds such as zinc stearate and barium stearate. Although dependent on the composition and activation characteristics of the blowing agent, activators are typically added at approximately a 1 to 1 ratio of activator to blowing agent.

Alternative void-producing materials may be added to the mixture in addition to or in place of a chemical blowing agent. For example, expandable hollow microspheres such as those produced by Expancel, Inc. may be added to the polymeric material. These microspheres are formed as spherical polymer shells encapsulating a gas. When heated, the shell softens and the gas pressure inside the shell increases. As a result, the microsphere expands. When dispersed in an uncured backing layer, the effect of the expandable microspheres is similar to that of a blowing agent. When the backing layer is heated, the microspheres expand creating voids in the backing layer. These voids are permanently established as the backing layer material is cured.

The chemical blowing agent and/or other void-producing materials should be thoroughly mixed with the ground polymeric materials and other additives in order to obtain a uniform dispersion. Uniform dispersion is preferred in order to ensure uniform thickness of the material after expansion.

Once the polymeric materials and the void-producing materials have been mixed, the mixture is heated to melt and blend the polymeric materials. It will be understood that this may be accomplished through the use of any suitable batch mixer (e.g., a Banbury® mixer) in which the material can be heated and blended. In a continuous process, however, this step is preferably accomplished using an extruder 50 as shown in FIG. 3. The extruder 50 provides a mechanism for continuously producing a uniform molten blend of the polymeric materials in which the blowing agent and other constituents are uniformly mixed.

A suitable extruder 50 is Model 2DS-K 57M32 or ZSK-170 M 1750 10 G, both available from Werner & Pfleiderer. The extruder 50 includes a control means 53 (e.g., a motor gearbox) and is fed by the feeder 55. A metal detection station, such as a magnet, may be located at the entrance of the feeder 55. A controller 53 is provided to insure that the extruder 50 and feeder 55 act cooperatively to maintain a constant feed condition throughout the conveying zone to one or more kneading zones. The fed materials then pass through an extruder barrel 57 that preferably includes a degassing or a vacuum zone. The materials are then passed through a pumping zone, which forces the materials through a die 58. The pumping zone functions to develop sufficient throughput without creating intolerable back pressures and torque in the preceding zones or on the thrust bearings of the extruder 50.

The extruder 50 is preferably operated at a temperature high enough to melt the non-fibrous thermoplastic polymer materials in the material mixture and produce a uniform, blended extrudate 59. However, if a blowing agent is included in the material mixture, the temperature in the extruder 50 is preferably kept below the decomposition temperature of the blowing agent to assure that the blowing agent is not activated during extrusion. For example, when an azodicarbonamide blowing agent is used, the extruder 50 is preferably operated such that a melt temperature of about 300° F. to 380° F. is maintained as the extruded blend 59 exits the die 58. Such temperatures are also well below the temperature (about 200° C. (392° F.) at which PVC molecules begin to degrade and generate HCl forming carbon-carbon double bonds.

Upon exit from the extruder die 58, the blended extrudate 59 may be passed through a metal detector 60. While still in a softened state, the extrudate 59 may be fed into a calendering unit 80, which forms the blended material of the extrudate into a uniform sheet. The dimensions of the extrudate 59 may be established so as to provide ease of handling and feeding of the calendering unit 80. In an illustrative embodiment, the extrudate 59 has a substantially circular cross-section with a diameter of about 3.0 in.

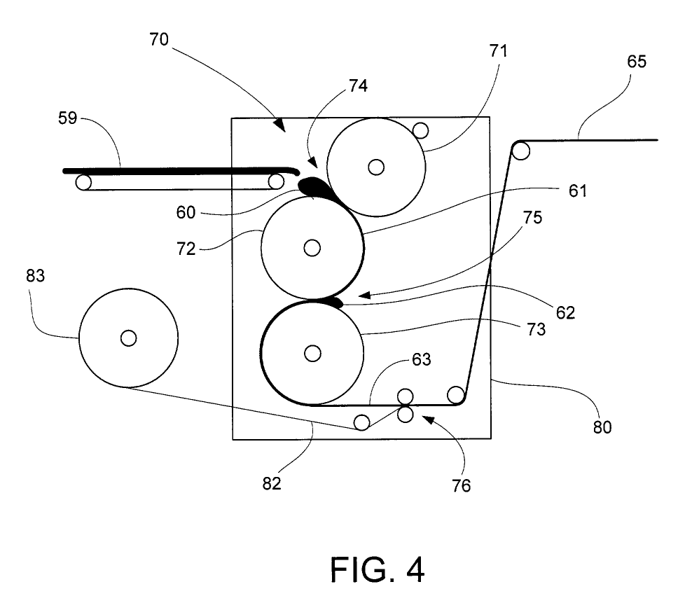

A variety of calender types may be used in the methods of the invention. As shown in FIGS. 3 and 4, a standard three cylinder calender 70 may be used. In one process using this calender 70, the extrudate 59 is fed to a first nip 74 between first and second counter-rotating, heated rolls 71, 72. The extruder 58 provides a continuous feed of material to the calender so that a constant reservoir or bank of material 60 is maintained at the first nip 74. An intermediate sheet 61 is formed as the material passes through the gap between the first and second rolls 71, 72.

The first and second rolls 71, 72 are rotated at different speeds so that the bank 60 of blended material ahead of the first nip 74 is constantly rolled and kneaded in the direction of the rotating rolls 71, 72. In an illustrative example wherein the rolls of the calender all have a diameter of about 24 inches, the second roll 72 may operate at about 5 rpm while the first roll 71 operates at about 4.5 rpm.

The intermediate sheet 61 is passed to a second nip 75 formed between the second roll 72 and a third heated roll 73. The third roll 73 operates at a faster speed than the second roll 72. In the illustrative example where the second roll 72 operates at about 5 rpm, the third roll 73 may operate at about 6 rpm. A second bank of material 62 collects ahead of the second nip 75 and, like the first bank 60, is constantly rolled in the direction of the rotating rolls. Shear and friction in the second bank 62 and the drawing of the intermediate sheet 61 between the second and third rolls 72, 73 further contribute to fiber alignment. The intermediate sheet 61 is thinned and widened as it passes through the second nip 75 to form a final calendered sheet 63.

It will be understood by those having ordinary skill in the art that, as an alternative to calendering, the sheet of waste polymeric material may be formed using a sheet die attachment in combination with the extruder 59 or may be formed using a second extruder with a sheet die. If a second extruder is used, the operating temperature of the second extruder is also kept below the decomposition temperature of the blowing agent. The sheet may also be produced using the method wherein a plastisol is deposited on a release belt.

The calendered sheet 63 (or sheet produced by the other methods discussed above) is then passed between a pair of press rolls 76 where it is pressed together with a sheet of reinforcing material 82 supplied from a reinforcing material roll 83. The reinforcing material 82 is preferably an open weave scrim material that retains its strength at the temperatures used to activate the blowing agent. Suitable materials include woven polyester and glass scrim. Non-woven or tissue type materials may also be used but such materials may necessitate the use of an additional adhesive layer when the final backing layer is bonded to the carpet back.

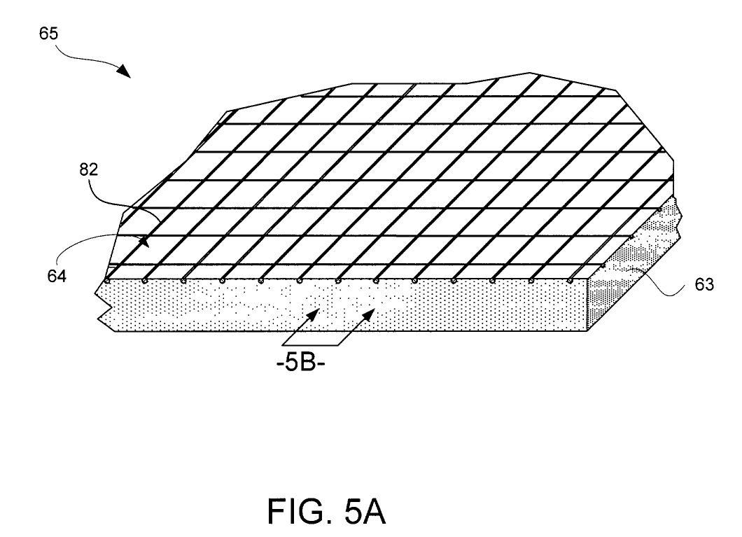

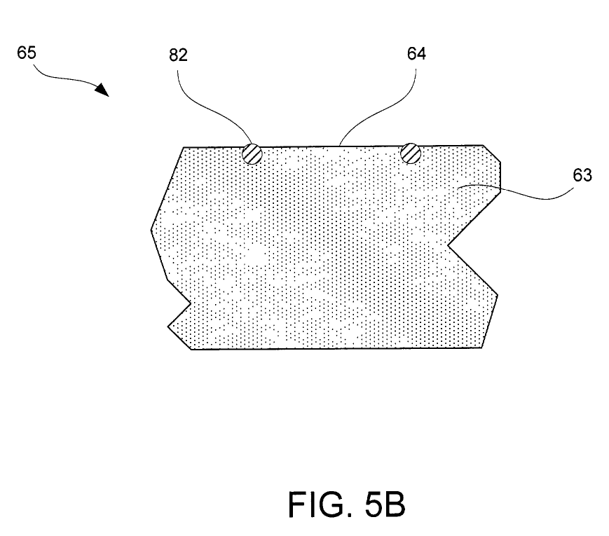

Because the reinforcing material 82 is pressed to the calendered sheet 63 while the calendered sheet 63 is still soft, the reinforcing material 82 is pressed into the surface 64 of the calendered sheet 63 to form a reinforced sheet 65. As shown in FIGS. 5A and 5B, the reinforcing material 82 is preferably substantially embedded within the calendered sheet 63, although a portion of the reinforcing material 82 may be exposed or even extend above the surface 64. The embedded reinforcing material 82 provides dimensional stability to the reinforced sheet 65 that is maintained through handling and further processing of the reinforced sheet 65. Moreover, the reinforcing material 82 prevents the buildup of residual stresses in the material that can cause non-uniform expansion when the void-producing material is activated.

At this point in the process, the void-producing material has not yet been activated. The reinforced sheet 65 may optionally be cooled at a cooling station and formed into rolls, which can then be transferred to another processing line or stored.

In a preferred embodiment of the process, however, the unexpanded reinforced sheet 65 is transported from the calendering unit 80 to an oven 90, where the sheet 65 is heated. If a chemical blowing agent is used, the sheet 65 is heated to a temperature above the decomposition temperature of the blowing agent. The reinforced sheet 65 is preferably supported and transported through the oven 90 by a conveyer 91. Although the reinforced sheet 65 may be passed through the oven 90 with the reinforcing material 82 facing away from the conveyer belt, it is preferred that the reinforcing material 82 face toward the conveyer belt.

The oven 90 is preferably configured to assure uniform heating and airflow over the entire reinforced sheet 65. The oven temperature is preferably in a range of about 300° F. to about 450° F. As the temperature in the reinforced sheet 65 exceeds the decomposition temperature of the blowing agent, gas pockets are formed that reduce the density and increase the thickness of the reinforced sheet 65, thereby producing a reinforced foam backing 66. Using a blowing agent level of approximately 1.5% (0.75% active) the reinforced foam backing 66 can reach a post-activation thickness that is 2 to 4 times the thickness of the unexpanded reinforced sheet 65. In a typical carpet backing, this corresponds to a density reduction from approximately 85 lbs/ft³ at 50 mils thickness to approximately 27 Ibs/ft³ at 150 mils thickness. Similar expansion may be accomplished using expandable microspheres.

After exiting the oven 90, the reinforced foam backing 66 may be cooled and accumulated into rolls at an accumulation station 92. The rolls of reinforced foam backing 66 may then be stored or transported to a carpet finishing line where the backing is adhered to a carpet product. Alternatively, after cooling, the reinforced foam backing 66 may be passed directly to a finishing station (not shown) where it is adhered to the carpet product. The reinforced foam backing 66 may also be used as a separate pad or cushion for placement underneath carpeting.

To bond the reinforced foam backing 66 to a pre-finished carpet having a polymeric pre-coat layer, heat is preferably applied to the reinforced side of the reinforced foam backing 66 and to the pre-coat layer of the carpet. The reinforced side of the reinforced foam backing 66 is then contacted with the pre-coat layer and the two layers are pressed together.

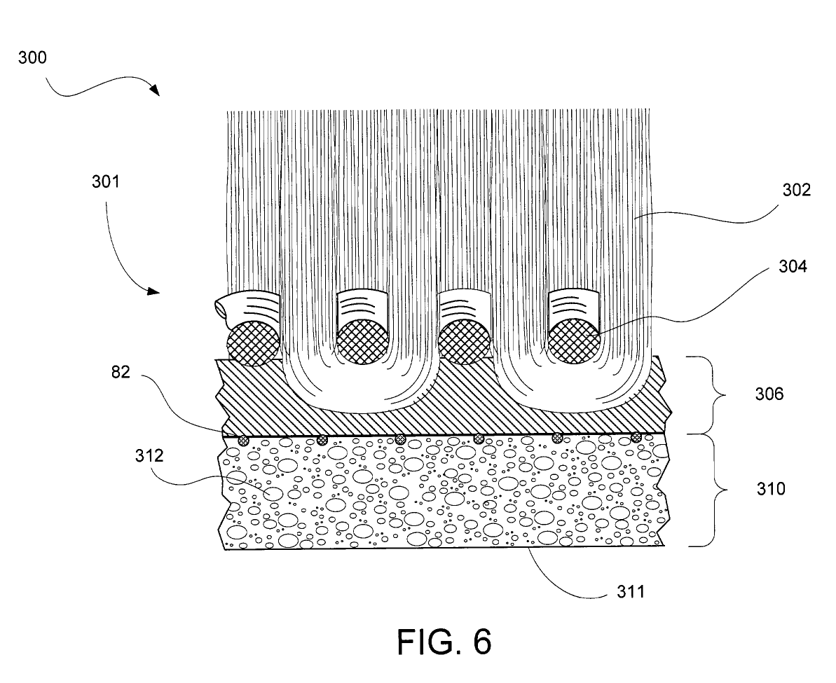

FIG. 6 illustrates a floor covering product 300 having a reinforced foam backing 310 produced using the above-described process. The floor covering product 300 comprises a tufted carpet 301 having looped pile yarns 302 tufted or looped through a primary backing 304 and extending upwardly therefrom. A polymeric pre-coat or backcoating 306 is used to fix the pile yarns 302 in place in the primary backing 304. The reinforced foam backing 310 includes a foam layer 311 comprising a plurality of substantially uniformly distributed closed cells 312. A substantially or entirely open cell foam backing may also be used. The foam layer 311 preferably comprises at least some of the previously discussed polymeric materials.

The reinforced foam backing 310 also comprises a reinforcing material 82 at least partially embedded in the upper surface of the foam layer 311. The reinforcing material 310 is preferably an open weave fabric or scrim formed from woven polyester or glass fibers.

It will be understood that the backing layer 310 may also be applied to a woven floor covering of the type depicted in FIG. 2. Both the tufted floor covering 300 and a similarly backed woven floor covering may be produced as roll goods or may be used to produce carpet tiles. In either case, a pressure self-release adhesive layer may be applied to the underside of the reinforced foam backing 310. If an adhesive layer is applied, a release cover may be applied over the adhesive.

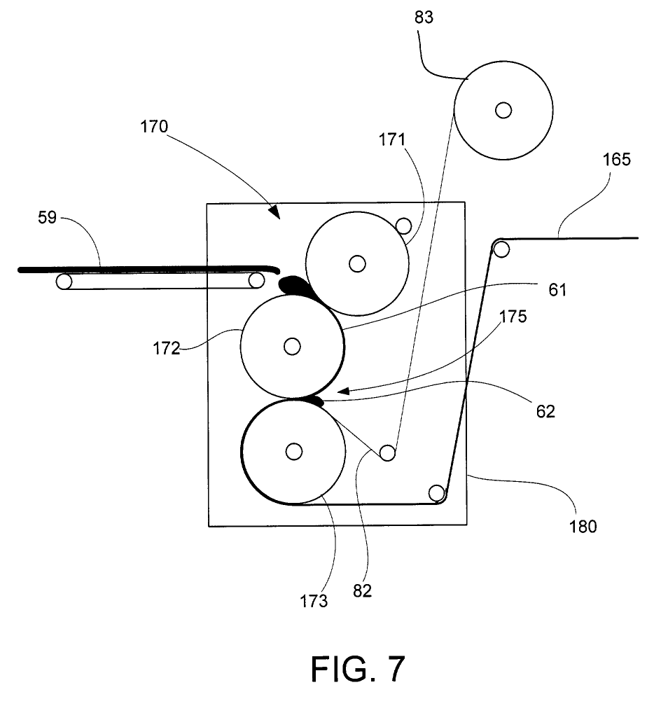

The present invention provides an alternate process that can also be used to produce the backing layer 310 of the floor covering 300. This process is substantially similar to that described above except for changes to the steps involved in forming the reinforced calendered sheet. The alternate process thus uses a processing line that is similar to that shown in FIG. 3 except for changes to the calendering unit. The alternate process uses the calendering unit 180 shown in FIG. 7. The calendering unit 180 uses a calender 170 having first, second and third rolls 171, 172, 173 to process the blended extrudate 59. Again each roll rotates at a different speed. In this process, however, instead of using separate press rolls to press the reinforcing material 82 into a final calendered sheet, the calendering unit 180 is configured so that the reinforcing material 82 is drawn through the nip 175 between the second and third rolls 172, 173 along with the intermediate sheet 61. The reinforcing material 82 is preferably fed into the nip 175 so that it passes between the surface of the third roll 173 and the material bank 62 that is maintained ahead of the nip 175. The output is a reinforced calendered sheet 165 in which the reinforcing material 82 is embedded in a substantially similar manner to the reinforcing material 82 of the reinforced calendered sheet 65 of the earlier process. The reinforced calendered sheet 165 is then passed to the oven 90 to produce the final reinforced foam backing 310.

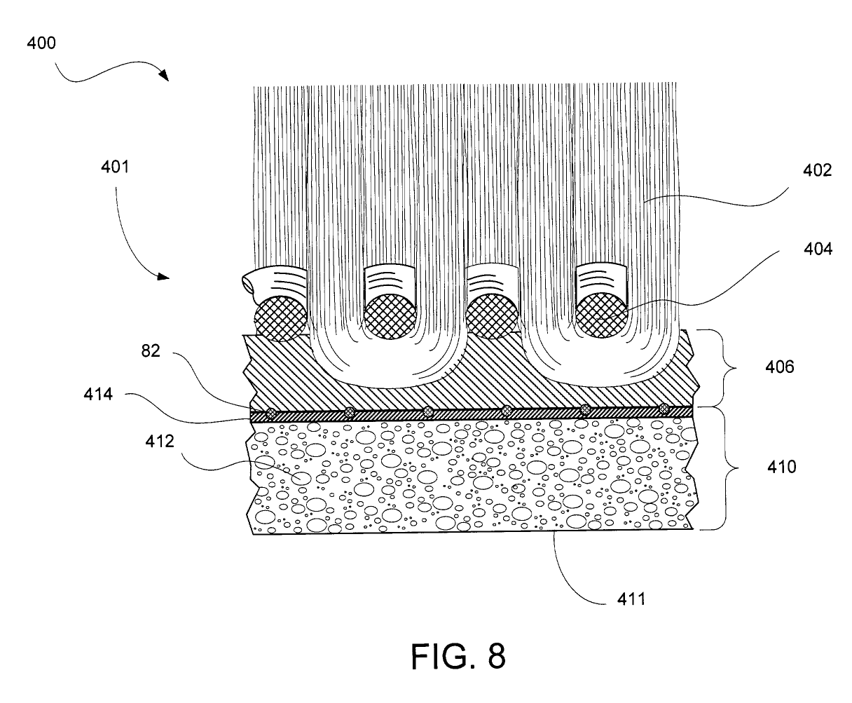

Another floor covering having a reinforced foam backing layer according to the present invention is shown in FIG. 8. The floor covering 400 comprises a tufted carpet 401 having looped pile yarns 402 tufted or looped through a primary backing 404 and extending upwardly therefrom. A polymeric pre-coat or backcoating 406 is used to fix the pile yarns 402 in place in the primary backing 404. The reinforced foam backing 410 includes a foam layer 411 comprising a plurality of substantially uniformly distributed closed cells 412. A substantially or entirely open cell foam backing may also be used. The foam layer 411 preferably comprises the previously discussed scrap materials and most preferably comprises the previously described waste polymeric carpet materials. These materials may include fibrous aliphatic polyamide polymer materials that are in at least partial alignment.

The reinforced foam backing 410 also comprises a reinforcing material 82 adhered to the upper surface of the foam layer 411 using an adhesive layer 414. The reinforcing material 410 is preferably an open weave fabric or scrim formed from woven polyester or glass fibers. The adhesive used must be selected for its ability to retain structural integrity and adherence to both the reinforcing material and the calendered sheet when subjected to the temperatures needed to activate the blowing agent. The choice of adhesive is dictated by the types of polymers in the materials to be adhered. The adhesive must be compatible with both the backing polymers and the pre-coat polymer to obtain a good bond. Suitable adhesives for use with vinyl pre-coat and vinyl backing materials may include VAE copolymer adhesives.

It will be understood that the reinforced foam backing layer 410 may also be applied to a woven floor covering of the type depicted in FIG. 2. Both the tufted floor covering 400 and a similarly backed woven floor covering may be produced as roll goods or may be used to produce carpet tiles. In either case, a pressure self-release adhesive layer and, if desired, a release cover may be applied to the underside of the reinforced foam backing 410.

The reinforced foam backing 410 may be manufactured using the process associated with the processing line shown in FIG. 3 but with the additional step of applying the adhesive layer 414 to the calendered sheet 63 prior to application of the reinforcing material 82. This method may be preferred if the calendered sheet 63 has been cooled and is no longer soft enough to embed the reinforcing material into the surface of the sheet. The combined adhesive layer 414 and reinforcing material 82 serve to maintain the dimensional stability of the reinforced calendered sheet through the expansion process to produce a substantially uniform reinforced foam backing 410.

The adhesive used to attach the reinforcing material 82 may also be used to adhere the reinforced foam backing 410 to the pre-coat 406 using the heat lamination process discussed earlier. Alternatively, an additional adhesive may be used.

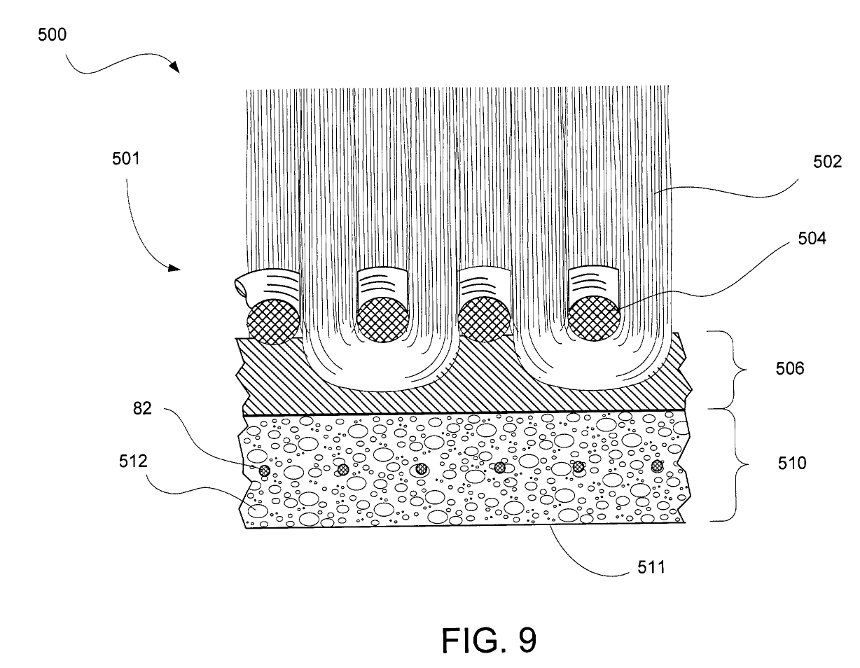

Yet another floor covering having a reinforced foam backing layer according to the present invention is shown in FIG. 9. The floor covering 500 comprises a tufted carpet 501 having looped pile yarns 502 tufted or looped through a primary backing 504 and extending upwardly therefrom. A polymeric pre-coat or backcoating 506 is used to fix the pile yarns 502 in place in the primary backing 504. The reinforced foam backing 510 includes a foam layer 511 comprising a plurality of substantially uniformly distributed closed cells 512. A substantially or entirely open cell foam backing may also be used. The foam layer 511 preferably comprises the previously discussed scrap materials and most preferably comprises the previously described waste polymeric carpet materials. These materials may include fibrous aliphatic polyamide polymer materials that are in at least partial alignment.

The reinforced foam backing 510 comprises a reinforcing material 513 entirely embedded within the foam layer 511. The reinforcing material 82 is preferably an open weave fabric or scrim but may also be a non-woven fabric, felt or tissue. The reinforcing material 82 is preferably formed from woven polyester or glass fibers.

The reinforced foam backing 510 may provide advantages with respect to bonding of the backing 510 to the pre-coat layer 506 and with respect to subsequent bond strength. This is because the reinforcing material 82 typically will not bond with the pre-coat material as well as the material of the foam layer 511. As a result, a better bond between the backing layer and the pre-coat layer can be achieved by completely submerging the reinforcing material 82 within the foam layer 511. This approach would be particularly suited to the use of non-woven and tissue reinforcing materials.

It will be understood that the reinforced foam backing 510 may also be applied to a woven floor covering of the type depicted in FIG. 2. Both the tufted floor covering 500 and a similarly backed woven floor covering may be produced as roll goods or may be used to produce carpet tiles. In either case, a pressure self-release adhesive layer and, if desired, a release cover may be applied to the underside of the reinforced foam backing 510.

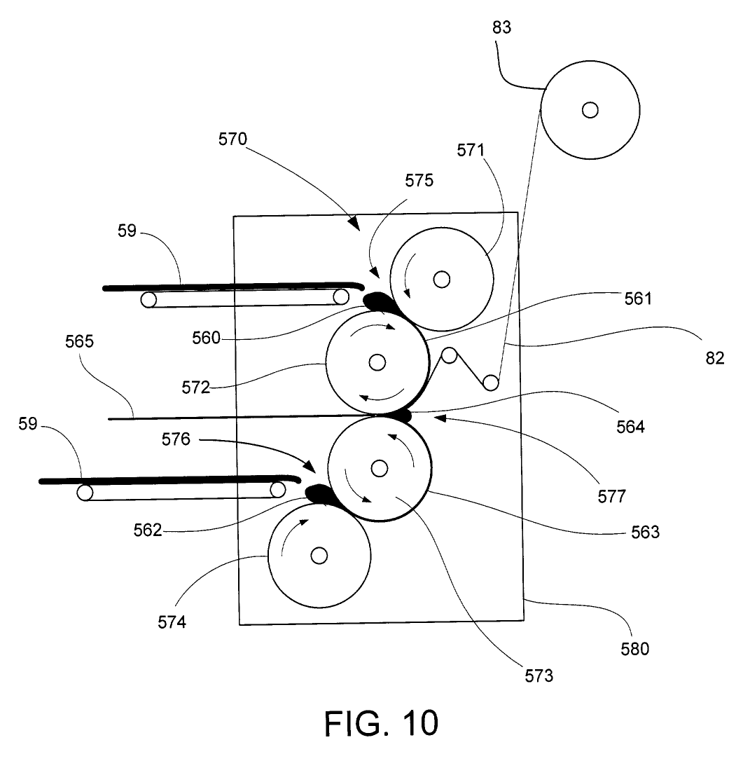

The reinforced foam backing 510 may be produced using a variation on the previously described manufacturing process. The process may be carried out using a processing line similar to that depicted in FIG. 3 but with a few significant differences. In this process, a reinforced calendered sheet 565 may be produced from the blended extrudate 59 using the calender unit 580 shown in FIG. 10. The calender unit 580 includes a calender 570 having four heated rolls 571, 572, 573, 574. In a process using this calender 570, the extrudate 59 is fed to the calender 570 in two places: a first nip 575 between the first and second counter-rotating, heated rolls 571, 572 and a second nip 576 between the third and fourth counter-rotating, heated rolls 573, 574. The first and fourth rolls 571, 574 rotate at a first speed and the second and third rolls 572, 573 rotate at a second speed that is higher than the first speed. A first bank of material 560 is maintained at the first nip 575 and a second bank of material 562 is maintained at the second nip 576. A first intermediate sheet 561 is formed as the material passes through the gap between the first and second rolls 571, 572 and a second intermediate sheet 563 is formed as the material passes through the gap between the third and fourth rolls 573, 574.

The first and fourth rolls 571, 574 are rotated at different speeds from the second and third rolls 572, 573 so that the banks 560, 562 of blended material are constantly rolled and kneaded in the machine direction.

The first and second intermediate sheets 561, 563 are pressed together by passing them both through a third nip 577 between the second and third rolls 572, 573. A reinforcing material 82 is fed continuously from a supply roll 83 to the third nip 577 between the first and second intermediate sheets 561, 563. The result is a reinforced calendered sheet 565 in which the reinforcing material is completely embedded. The calendered sheet 565 can then be cooled and rolled or passed to an oven where it is expanded to form reinforced foam backing 510.

Because the calender 570 must be continuously fed in two places, additional changes to the processing line may be required. These may include configuring the line to divide the extrudate 59 before delivery to the calender 570 or providing two separate extruders 50. It will be understood that using multiple extruders would reduce the required throughput of each extruder 50 since the total amount of extruded material required for the foam backing 510 would be about the same as for the other foam backing embodiments.

It will be understood by those having ordinary skill in the art that, as an alternative to calendering, the intermediate sheets 561, 563 could be formed using a sheet die. The unexpanded reinforced sheet 565 could then be produced by pressing the intermediate sheets 561, 563 together with the reinforcing material 82 sandwiched therebetween.

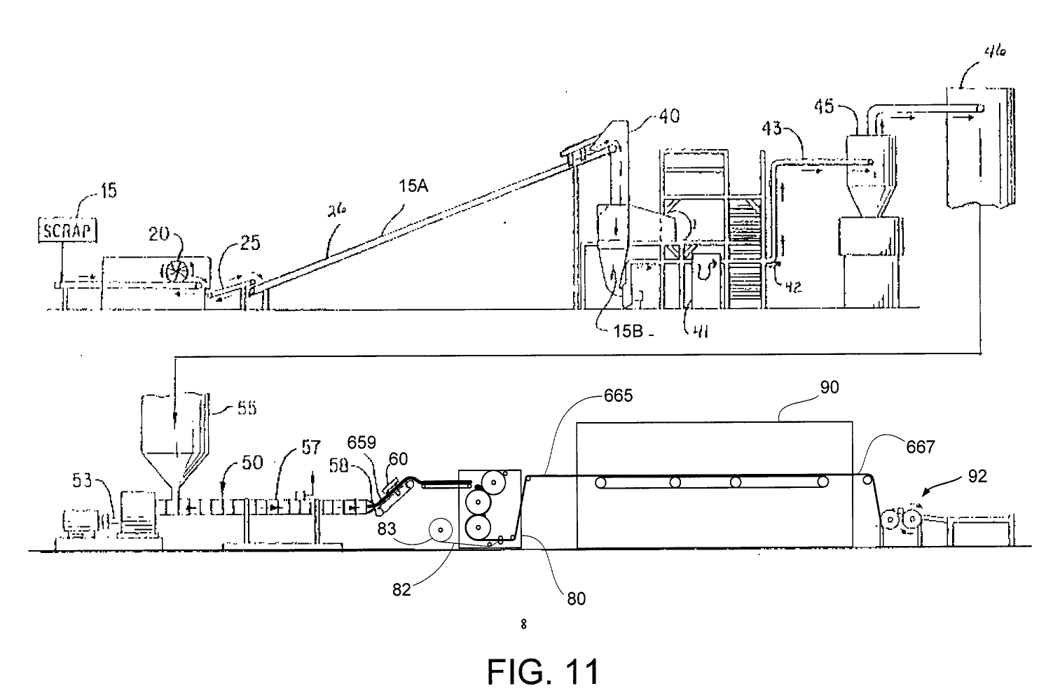

The above-described processes may also be used to manufacture reinforced foam backing layers using waste polymeric materials and, more particularly, waste polymeric carpet materials. A recycling/manufacturing process line incorporating the reinforced backing methodologies is illustrated in FIG. 11. In this process line, waste polymeric material (scrap) 15, such as carpet remnants or carpet tiles, are chopped, granulated, densified and fed to an extruder 50 along with a blowing agent or other void producing material to form a uniform, blended extrudate 659. This extrudate 659 is then continuously fed to a calendering unit 80 to form a reinforced sheet 665 from the extruded material 659. The reinforced sheet 665 may then be passed through an oven to activate the blowing agent or other void-producing material to form substantially uniform voids through out the sheet, thereby expanding and imparting cushioning properties thereto.

The recycling/manufacturing process will now be discussed in more detail. The waste polymeric material 15 is initially delivered to a guillotine chopper 20. The waste polymeric material 15 typically comprises a wide variety of thermoplastic material generated during the manufacture of floor coverings and generated in the disposal of used floor coverings. Typical thermoplastic materials that may be present include aliphatic polyamides and/or other fibrous materials, polyolefins (e.g., polyethylene and polypropylene), polymers based on vinyl monomers (e.g., vinyl chloride and vinyl esters such as vinyl acetate), polymers based on acrylic monomers (e.g., acrylic acid, methyl acrylic acid, esters of these acids, and acrylonitrile), other thermoplastic polymers, and blends and copolymers thereof. Other materials that are typically present in the scrap material include any of various plasticizers, inorganic fillers, inorganic flame retardants, organic flame retardants, fiberglass, blowing agents, polyester, pigments, stabilizers, oils and processing aids and antisoiling or antistaining chemicals.

The fibrous materials that may be present in the material 15 can range in the amount of about 0 to about 40 percent of the total amount of material 15, but are normally approximately 12% of the total amount of material 15. The fibrous materials add strength (stability) to the final recycled backing product. In particular, it has been found that the aliphatic polyamides increase the tear resistance and breaking strength and decrease the elongation and shrinkage of the final product.

The waste polymeric material may include aliphatic polyamide polymers. The term “aliphatic polyamide polymer” used herein and throughout the specification may include, but is not limited to, long-chain polymeric or copolymeric amide which has recurring amide groups as an integral part of the main polymer or copolymer chain, which may be in the form of a fiber. Examples of aliphatic polyamides can include wool, nylon 6 or poly (ωcaprolactam); nylon 66 or poly (hexamethylenedia mine-adipic acid) amide; poly (hexamethylenediamine-sebacic acid) amide or nylon 610; and the like.

When present in fibrous form in the final manufactured product, alignment of the aliphatic polyamide polymers in the product material may add to the strength of the material, particularly the tear strength of the material lateral to the direction of fiber alignment.

The guillotine chopper 20 may be any conventional guillotine chopper that coarsely chops the waste polymer material into ¾ to 1 inch in width portions. A suitable guillotine chopper is Model CT-60 available from Pieret, Inc. The chopped mixture 26a, which is free of most metal, is transported, for example, via conveyer belts 25 and 26 to a granulator 40, which grinds the one inch portions into fragments at least an order of magnitude smaller than the original size of waste polymeric material. Typically this is about ⅜ inch and smaller. A suitable granulator is Model 24-1 available from Cumberland Company.

The granulated material 15b is typically in the form of a fluffy, fibrous material and solid polymeric particles. The granulated mixture 15b may be transported to a densifier 41, which forms the granulated mixture into a densified material 42. The densifier 41 is preferably designed to heat, melt, and form or compact the granulated mixture 15b into semi-uniform pellets. These pellets increase the throughput of the extruder 50 and allow the extruder 50 to produce a more uniform blend of molten recycled material. A densifier 41, such as a Plastcompactor Pelletizer Model No. CV50, manufactured by HERBOLD ZERKLEINERUNGSTECHNIK GmbH, has an approximate volume densification ratio of 2:1 (original granulated material to densified material volume). The use of the densifier 41 may increase the output of the extruder 50 from approximately 1,000 lbs. per hour to approximately 4,000 to 6,000 Ibs. per hour.

Optionally, if a finer material is required, the densified, pelletized material 42 can be sent via a conveyor to a cryogenic grinder (not shown) that uses liquid nitrogen to freeze and grind the densified, pelletized material 42 to form a hard cryogenically ground material that is fed into the extruder 50. The cryoground material may be made up of particles that are on the order of 0.01-0.20 inches in diameter. These particles may be screened to remove particles larger than a desired limit.

Cryogenic grinding may also be used as an alternative to or as a precedent step to the densification of the granulated material 15b. Under this alternative, the granulated mixture 15b can be sent via a conveyor 26 to a cryogenic grinder (not shown). The cryogenically ground material can then be sent either to the densifier 41 or directly to the extruder 50.

The densified material and/or cryogenically ground material 42 may be transported via air in a conduit 43 to a Gaylord loading station 45 and/or to a silo 46. If desired, fines, dust and/or fibers can be removed and separated from the densified material and/or cryogenically ground material 42.

The densified material and/or cryogenically ground material 42 is then conveyed to the extruder feeder 55 which feeds the extruder 50. Additional recycled material such as granulated waste PVC may be added to the waste polymeric material 42 in the hopper. Virgin (i.e., non-recycled) material may also be added.

A chemical blowing agent is preferably added to the densified material and/or cryogenically ground material 42 in the feeder 55. As in the previously described methodology, blowing agents can be added in liquid, powder or pellet form. Heat-activated azodicarbonamide (azo) products are particularly suitable. Other chemical blowing agents that may be used in the invention include, but are not limited to, p-toluene sulfonyl semicarbizide or p,p oxybis benzene sulfonyl hydrazide (OBSH). The activation or decomposition rate of any of these blowing agents can be altered through the use of an activator as described above. Other void-producing materials such as expandable microspheres may be added as an alternative to or in addition to the chemical blowing agent.

The blowing agent (and activator if desired) should be thoroughly mixed with the densified material and/or cryogenically ground material 42 and other additives in order to obtain a uniform dispersion. Uniform dispersion is essential to ensure uniform thickness of the material after expansion.

It has been found that retaining some fibers in the material can result in enhanced strength of the final foam product. However, if a very fine cell structure is desired, the fibrous material may be removed from the recycled material or reduced to non-fibrous or powder-like proportions. Fibrous material may be removed from the waste polymeric material through elutriation or an equivalent process. It has been found, however, that a fine cell structure can be produced by cryogenically grinding the densified pelletized material to form a fine powder, which may then be mixed with the blowing agent in the feeder 55.

Once the densified waste polymeric material and blowing agent have been mixed, the mixture is heated to melt and blend the non-fibrous thermoplastic polymeric materials. It will be understood that this may be accomplished through the use of any suitable batch mixer (e.g., a Banbury® mixer) in which the material can be heated and blended. In a continuous process, however, this step is preferably accomplished using the extruder 50. The extruder 50 provides a mechanism for continuously producing a uniform molten blend of the waste polymeric material in which the aliphatic polyamides, blowing agent and other constituents are uniformly mixed.

As discussed above, a suitable extruder 50 is Model 2DS-K 57M32 or ZSK-170 M 1750 10 G, both available from Werner & Pfleiderer. The extruder 50 includes a control means 53 (e.g., a motor gearbox) and is fed by the feeder 55. A metal detection station, such as a magnet, may be located at the entrance of the feeder 55. A controller 53 is provided to insure that the extruder 50 and feeder 55 act cooperatively to maintain a constant feed condition throughout the conveying zone to one or more kneading zones. The fed materials then pass through an extruder barrel 57 which preferably includes a degassing or a vacuum zone. The materials are then passed through a pumping zone which forces the materials through a die 58. The pumping zone functions to develop sufficient throughput without creating intolerable back pressures and torque in the preceding zones or on the thrust bearings of the extruder 50.

The extruder 50 is operated at a temperature high enough to melt the non-fibrous thermoplastic polymer materials in the recycled material mixture and produce a uniform, blended extrudate 659. However, the temperature in the extruder 50 is kept below the decomposition temperature of the blowing agent to assure that the blowing agent in the material mixture is not activated during extrusion. For example, when an azodicarbonamide blowing agent is used, the extruder 50 is preferably operated such that a melt temperature of about 300° F. to 380° F. is maintained as the extruded blend 59 exits the die 58. Such temperatures are also well below the temperature (about 200° C. (392° F.)) at which PVC molecules begin to degrade and generate HCl forming carbon-carbon double bonds.

Upon exit from the extruder die 58, the blended extrudate 659 may be passed through a metal detector 60. While still in a softened state, the extrudate 659 is fed into a calendering unit 80, which forms the blended material of the extrudate into a uniform sheet. The dimensions of the extrudate 659 may be established so as to provide ease of handling and feeding of the calendering unit 80. In an illustrative embodiment, the extrudate 659 has a substantially circular cross-section with a diameter of about 3.0 in.

Each of the previously described calender types may be used to process the blended extrudate 659. Thus, the calendering unit 80 may be replaced by the calendering units 180, 580 of FIGS. 7 and 10, respectively. If the calendering unit 80 is used, the calender 70 of FIG. 4 is used to form an unreinforced sheet of waste polymeric material. A reinforcing material may then be pressed to the unreinforced sheet by passing the sheet and the reinforcing material through a pair of press rolls 76.

It will be understood by those having ordinary skill in the art that, as an alternative to calendering, the sheet of waste polymeric material may be formed using a sheet die attachment in combination with the extruder 59 or may be formed using a second extruder with a sheet die. If a second extruder is used, the operating temperature of the second extruder is also kept below the decomposition temperature of the blowing agent. In either of these process embodiments, it is preferred that the recycled material 66 be formed from powdered waste polymeric material that has been cryoground. This reduces fiber length, which helps to prevent clogging of the sheet die. Alternatively, an elutriation or similar process may be used to remove the majority of the fibrous material before the material is melted and extruded.

The unreinforced sheet may also be produced using the method wherein a plastisol is deposited on a release belt. In this case, the reinforcing material would be applied to the plastisol material without the use of press rolls. The reinforcing material may be simply laid on top of the plastisol layer or, alternatively, the plastisol may be cast on top of the reinforcing material.

Although non-calendering methods can be used to produce the sheet of waste polymeric material, there are significant advantages to producing the sheet by calendering. When processed using the calender 70, the extrudate 659 is fed to the first nip 74 so that a constant reservoir or bank of material 60 is maintained at the first nip 74. An intermediate sheet 61 is formed as the material passes through the gap between the first and second rolls 71, 72.

As previously discussed, the first and second rolls 71, 72 are rotated at different speeds so that the bank 60 of blended waste material ahead of the first nip 74 is constantly rolled and kneaded in the direction of the rotating rolls 71, 72. It has been found that the shear stress and kneading action as the blended recycled material is rolled in the bank 60 and through the nip 74 of the rolls 71, 72 tends to cause alignment of material fibers in the machine direction. This effect contributes to the enhanced strength characteristics of the final sheet product. Friction and shear forces from the differential speed of the rolls 71, 72 also contribute to fiber alignment.

The intermediate sheet 61 is passed to the second nip 75 formed between the second roll 72 and a third heated roll 73. The third roll 73 operates at a faster speed than the second roll 72 and a second bank of material 62 collects ahead of the second nip 75. Like the first bank 60, the second bank 62 is constantly rolled in the direction of the rotating rolls. Shear and friction in the second bank 62 and the drawing of the intermediate sheet 61 between the second and third rolls 72, 73 further contribute to fiber alignment in the final unreinforced sheet.

If calendered or extruded, the unreinforced sheet is passed between the pair of press rolls 76 where it is pressed together with the sheet of reinforcing material 82 supplied from the reinforcing material roll 83. As in previous embodiments, the reinforcing material 82 is preferably an open weave scrim material that retains its strength at the temperatures used to activate the blowing agent. Suitable materials include woven polyester and glass scrim. Non-woven or tissue type materials may also be used but such materials may necessitate the use of an additional adhesive layer when the final backing layer is bonded to the carpet back.

Because the reinforcing material 82 is pressed to the unreinforced sheet while the unreinforced sheet is still soft, the reinforcing material 82 is pressed into the surface 64 of the unreinforced sheet to form a reinforced sheet 665. The reinforcing material 82 is preferably substantially embedded within the sheet. As before, the embedded reinforcing material 82 provides dimensional stability to the reinforced sheet 665 that is maintained through handling and further processing of the reinforced sheet 665. Moreover, the reinforcing material 82 prevents the buildup of residual stresses in the material that can cause non-uniform expansion when the blowing agent is activated.

At this point in the process, the blowing agent (or other void-producing material) has not yet been activated. The reinforced sheet 665 may be cooled at a cooling station and formed into rolls, which can then be transferred to another processing line or stored.

In a preferred embodiment of the process, however, the unexpanded reinforced sheet 665 is transported from the calendering unit 80 to an oven 90, where the sheet is heated to a temperature above the decomposition temperature of the azo blowing agent. The reinforced sheet 665 is preferably supported and transported through the oven 90 by a conveyer 91 . Although the reinforced sheet 665 may be passed through the oven 90 with the reinforcing material 82 facing away from the conveyer belt, it is preferred that the reinforcing material 82 face toward the conveyer belt.

The oven 90 may be configured as previously described. As the temperature in the reinforced sheet 665 exceeds the decomposition temperature of the blowing agent, gas pockets are formed that reduce the density and increase the thickness of the reinforced sheet 65, thereby producing a reinforced foam backing 667. Again, using a blowing agent level of approximately 1.5% (0.75% active) the reinforced foam backing 667 can reach a post-activation thickness that is 2 to 4 times the thickness of the unexpanded reinforced sheet 665.

After exiting the oven 90, the reinforced foam backing 667 may be cooled and accumulated into rolls at an accumulation station 92. The rolls of reinforced foam backing 667 may then be stored or transported to a carpet finishing line where the backing is adhered to a carpet product. Alternatively, after cooling, the reinforced foam backing 667 may be passed directly to a finishing station (not shown) where it is adhered to the carpet product. The reinforced foam backing 667 may also be used as a separate pad or cushion for placement underneath carpeting.

To bond the reinforced foam backing 667 to a pre-finished carpet having a polymeric pre-coat layer, heat is preferably applied to the reinforced side of the reinforced foam backing 667 and to the pre-coat layer of the carpet. The reinforced side of the reinforced foam backing 667 is then contacted with the pre-coat layer and the two layers are pressed together.

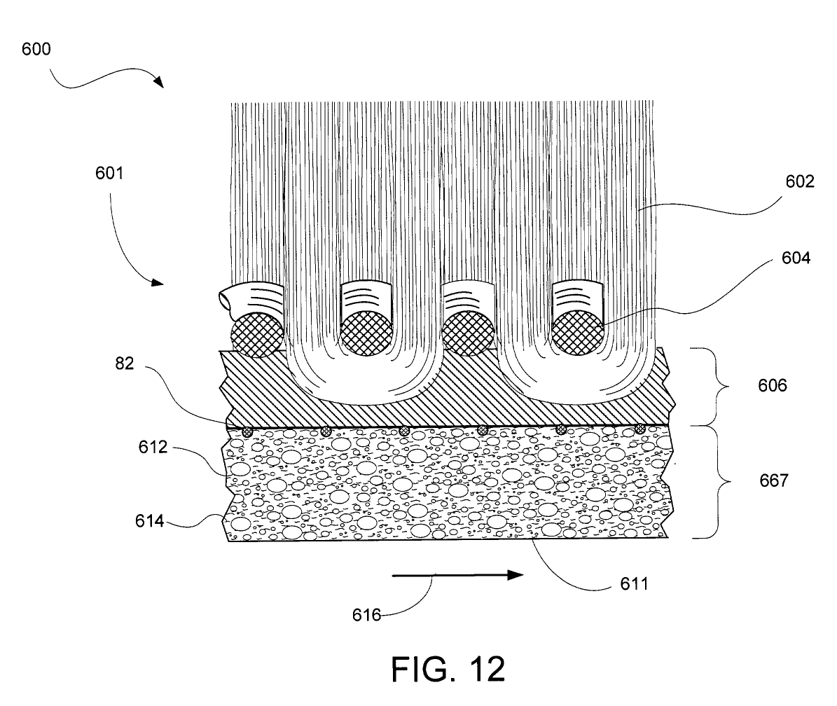

FIG. 12 illustrates a floor covering product 600 having a reinforced foam backing 667 formed from waste polymeric material using the above-described process. The floor covering product 600 comprises a tufted carpet 601 having looped pile yarns 602 tufted or looped through a primary backing 604 and extending upwardly therefrom. A polymeric pre-coat or backcoating 606 is used to fix the pile yarns 602 in place in the primary backing 604. The reinforced foam backing 667 includes a foam layer 611 that preferably comprises one or more of the previously discussed scrap materials and most preferably comprises waste polymeric carpet materials. The foam layer also comprises a plurality of substantially uniformly distributed closed cells 612. A foam layer being formed substantially or entirely as an open cell structure may also be used.

The foam layer 611 may comprise fibrous materials 614 that have retained their fibrous form. As previously discussed, these materials tend to be aligned in the machine direction 616 in the calendering process described above, and this tends to have a positive effect on tear strength in the cross-machine direction. This effect has been shown to be retained even after expansion of the calendered sheet. Accordingly, the fibers 614 in the final foam layer 611 remain, at least to some degree, aligned in a direction corresponding to the machine direction 616, despite the presence of the cells 612.

It will be understood that the backing layer 667 may also be applied to a woven floor covering of the type depicted in FIG. 2. Both the tufted floor covering 600 and a similarly backed woven floor covering may be produced as roll goods or may be used to produce carpet tiles. In either case, a pressure self-release adhesive layer may be applied to the underside of the reinforced foam backing 667. If an adhesive layer is applied, a release cover may be applied over the adhesive.

The processes of the invention may also be used to produce a reinforced foam backing of the type shown in FIG. 8 but with the backing formed from waste polymeric material. The foam layer of such a backing would be substantially similar to the foam layer 611 of FIG. 12. However, instead of being embedded in the upper surface of the foam layer, the reinforcing material 82 would be adhered to the upper surface of the foam layer using an adhesive layer similar to the adhesive layer 414 of FIG. 8. Such reinforced foam backing layers formed from waste polymeric material may be used on both tufted and woven floor coverings and may be used in both roll goods and carpet tiles. A pressure self-release adhesive layer and, if desired, a release cover may be applied to the underside of the reinforced foam backing.

The processes of the invention may also be used to produce a reinforced foam backing similar to that shown in FIG. 9 but with the backing formed from waste polymeric material. Again, the foam layer would be substantially similar to the foam layer 611 of FIG. 12. However, instead of being embedded in the upper surface of the foam layer, the reinforcing material 82 would be entirely embedded within the foam layer 611 in the manner shown in FIG. 9. Such reinforced foam backing layers formed from waste polymeric material may be used on both tufted and woven floor coverings and may be used in both roll goods and carpet tiles. Again, a pressure self-release adhesive layer and, if desired, a release cover may be applied to the underside of the reinforced foam backing.

The recycled reinforced foam backing with a fully embedded reinforcing layer may be produced using the calender unit 580 (see FIG. 10) in the manner previously described. In this process, the blended waste polymeric material is fed to the calender 570 so as to form banks 560, 562 and the first and second nips. The banks 560, 562 of blended material are constantly rolled and kneaded in the machine direction. This produces a similar fiber alignment to that produced in the three roll calender 70. Passage through the first and second nips produces intermediate sheets of waste polymeric material. A reinforcing material 82 is fed continuously from a supply roll 83 to the third nip 577 between the intermediate sheets of waste polymeric material. The result is an unexpanded reinforced sheet in which the reinforcing material is completely embedded. The unexpanded reinforced sheet can then be cooled and rolled or passed to an oven where it is expanded to form a final reinforced foam backing.

It will be understood by those having ordinary skill in the art that, as an alternative to calendering, the intermediate sheets of waste polymeric material could be formed using a sheet die. The unexpanded reinforced sheet could then be produced by pressing the intermediate sheets together with the reinforcing material 82 sandwiched therebetween.

Floor covering products having the reinforced foam backing layers described herein have significant advantages in dimensional stability over similar but non-reinforced floor coverings. Further, the reinforced floor coverings of the present invention may have both material and process cost advantages over other reinforced products. Moreover, the processes of the present invention require only minimal changes to existing processing lines.

Other embodiments and uses of the invention will be apparent to those skilled in the art from consideration of the specification and practice of the invention disclosed herein. The specification and examples should be considered exemplary only. The scope of the invention is limited only by the claims appended hereto.

What is claimed is:

1. A reinforced foam backing for a floor covering, the reinforced foam backing comprising:
a foam layer comprising at least one thermoplastic polymeric material, the foam layer having a plurality of voids substantially uniformly distributed therein; and
a reinforcing material attached to the foam sheet.

2. A reinforced foam backing according to claim 1 wherein the foam layer comprises a plurality of gas-tight cells.

3. A reinforced foam backing according to claim 1 wherein the reinforcing material is at least partially embedded within the foam layer.

4. A reinforced foam backing according to claim 1 wherein the reinforcing material is completely embedded within the foam layer.

5. A reinforced foam backing according to claim 1 further comprising an adhesive layer applied to a surface of the foam layer, the reinforcing material being adhered to the foam layer by the adhesive layer.

6. A reinforced foam backing according to claim 1 wherein the reinforcing material is an open weave fabric.

7. A reinforced foam backing according to claim 6 wherein the open weave fabric is formed from at least one of a polyester fiber material and a glass fiber material.

8. A reinforced foam backing according to claim 1 wherein the at least one thermoplastic polymeric material comprises at least one of a polyolefin, a polymer based on vinyl monomers and a polymer based on acrylic monomers.

9. A reinforced foam backing according to claim 1 wherein the foam layer comprises a waste polymeric material including at least one non-fibrous thermoplastic material and from about 0 to about 40 percent fiber material.

10. A reinforced foam backing according to claim 1 wherein the foam layer comprises a waste polymeric material including at least one non-fibrous thermoplastic material and from about 0 to about 40 percent aliphatic polyamide material.

11. A reinforced foam backing according to claim 10 wherein the aliphatic polyamide material includes at least one of wool, nylon 6, nylon 66 and nylon 610.

12. A reinforced, cushioned floor covering comprising:
a carpet having textile fibers and a polymeric pre-coat layer, at least a portion of the textile fibers being embedded in the polymeric pre-coat layer; and
a reinforced foam backing comprising
a foam layer comprising at least one thermoplastic polymeric material, the foam layer having a plurality of voids substantially uniformly distributed therein; and,
a reinforcing material at least partially embedded in the foam sheet.

13. A reinforced, cushioned floor covering according to claim 12 wherein the foam layer comprises a plurality of gas-tight cells.

14. A reinforced, cushioned floor covering according to claim 12 wherein the reinforcing material is completely embedded within the foam layer.

15. A reinforced, cushioned floor covering according to claim 12 wherein the reinforcing material is an open weave fabric.

16. A reinforced, cushioned floor covering according to claim 15 wherein the open weave fabric is formed from one of a polyester fiber material and a glass fiber material.

17. A reinforced, cushioned floor covering according to claim 12 wherein the at least one thermoplastic polymeric material comprises at least one of a polyolefin, a polymer based on vinyl monomers and a polymer based on acrylic monomers.

18. A reinforced, cushioned floor covering according to claim 12 wherein the carpet further comprises a primary backing and tufted pile yams formed from the textile fibers, the tufted pile yarns being looped through the primary backing and secured to the primary backing by the polymeric pre-coat layer.

19. A reinforced, cushioned floor covering according to claim 12 wherein the carpet further comprises warp and weft yarns formed from the textile fibers, at least a portion of the warp and weft yarns being coated by the polymeric pre-coat layer.

20. A reinforced, cushioned floor covering according to claim 12 further comprising a pressure self-release adhesive layer attached to the reinforced foam backing.

21. A reinforced, cushioned floor covering according to claim 12 wherein the foam layer comprises a waste polymeric material including at least one non-fibrous thermoplastic material and from about 0 to about 40 percent fibrous material.

22. A reinforced, cushioned floor covering according to claim 12 wherein the foam layer comprises a waste polymeric material including at least one non-fibrous thermoplastic material and from about 0 to about 40 percent aliphatic polyamide material.

23. A reinforced, cushioned floor covering according to claim 22 wherein the aliphatic polyamide material includes at least one of wool, nylon 6, nylon 66 and nylon 610.

24. A reinforced, cushioned floor covering comprising:
a carpet having textile fibers and a polymeric pre-coat layer, at least a portion of the textile fibers being embedded in the polymeric pre-coat layer; and
a reinforced foam backing comprising
a foam layer comprising a waste polymeric material including at least one non-fibrous thermoplastic material and from about 0 to about 40 percent aliphatic polyamide material, the foam layer having a plurality of gas-tight cells substantially uniformly distributed therein, and
an open weave fabric at least partially embedded in the foam sheet, the open weave fabric being formed from at least one of a polyester fiber material and a glass fiber material.

25. A reinforced, cushioned floor covering according to claim 24 wherein the open weave fabric is completely embedded within the foam layer.

26. A reinforced, cushioned floor covering according to claim 24 wherein the aliphatic polyamide material includes at least one of wool, nylon 6, nylon 66 and nylon 610.

27. A reinforced, cushioned floor covering according to claim 24 wherein the at least one non-fibrous thermoplastic material comprises at least one of a polyolefin, a polymer based on vinyl monomers and a polymer based on acrylic monomers.

28. A method of manufacturing a reinforced foam backing for a floor covering, the method comprising:
forming a polymeric material mixture comprising at least one thermoplastic polymeric material and a void-forming material;
heating the polymeric material mixture to melt the at least one thermoplastic polymeric material;
forming a first intermediate sheet from the heated polymeric material mixture;
forming a reinforced sheet comprising the first intermediate sheet and a reinforcing material attached to the first intermediate sheet; and
heating the reinforced sheet to activate the void-forming material to cause the reinforced sheet to expand to form the reinforced foam backing.

29. A method according to claim 28 wherein the void-forming material comprises a blowing agent having a predetermined decomposition temperature and wherein the step of heating the reinforced sheet includes heating the reinforced sheet to a temperature above the decomposition temperature of the blowing agent, thereby causing the reinforced sheet to expand to form the reinforced foam backing.

30. A method according to claim 28 further comprising the step of adhering the reinforced foam backing to a back surface of a floor covering.

31. A method according to claim 28 wherein the step of forming a reinforced sheet includes:
embedding at least a portion of the reinforcing material into the first intermediate sheet.

32. A method according to claim 28 wherein the step of forming a reinforced sheet includes:
applying an adhesive layer to a surface of the first intermediate sheet; and
adhering the reinforcing material to the first intermediate sheet using the adhesive layer.

33. A method according to claim 28 wherein the step of forming a reinforced sheet includes:
calendering the heated polymeric material mixture to form the first intermediate sheet; and
pressing the reinforcing material and the first intermediate sheet together.

34. A method according to claim 33 wherein the step of forming a reinforced sheet further includes:
extruding the heated polymeric material mixture to form a blended extrudate for use in the calendering step.

35. A method according to claim 28 wherein the step of forming a reinforced sheet includes:
extruding the heated polymeric material mixture through a sheet die to form the first intermediate sheet; and
pressing the reinforcing material and the first intermediate sheet together.

36. A method according to claim 28 wherein the step of forming a reinforced sheet includes:
drawing the heated polymeric material mixture through a first nip between first and second calender rolls to form the first intermediate sheet; and
drawing the first intermediate sheet and the reinforcing material through a second nip between the second calender roll and a third calender roll.

37. A method according to claim 28 wherein the step of forming a reinforced sheet includes:
drawing a first portion of the heated polymeric material mixture through a first nip between first and second calender rolls to form the first intermediate sheet;
drawing a second portion of the heated polymeric material mixture through a second nip between third and fourth calender rolls to form a second intermediate sheet; and
drawing the first and second intermediate sheets and the reinforcing material through a third nip between the second calender roll and the third calender roll, the reinforcing material being positioned between the first and second intermediate waste polymeric material sheets.

38. A method according to claim 28 wherein the polymeric material mixture comprises a waste polymeric material including at least one non-fibrous thermoplastic material and from about 0 to about 40 percent aliphatic polyamide material.

39. A method of manufacturing a reinforced foam backing for a floor covering, the method comprising:
granulating a mixture of waste polymeric material including at least one non-fibrous thermoplastic material and from about 0 to about 40 percent aliphatic polyamide material to produce a granulated waste polymeric material mixture;
adding a blowing agent having a predetermined decomposition temperature to the mixture of waste polymeric material to form a blowing agent and waste polymeric material mixture;
forming a reinforced sheet comprising a first intermediate waste polymeric material sheet formed from the blowing agent and waste polymeric material mixture and a reinforcing material adhered to the first intermediate waste polymeric material sheet; and
heating the reinforced sheet to a temperature above the decomposition temperature of the blowing agent, thereby causing the reinforced sheet to expand to form the reinforced foam backing.

40. A method according to claim 39 further comprising the step of adhering the reinforced foam backing to a back surface of a floor covering.

41. A method according to claim 39 wherein the step of forming a reinforced sheet includes:
embedding at least a portion of the reinforcing material into the first intermediate waste polymeric material sheet.

42. A method according to claim 39 wherein the step of forming a reinforced sheet includes:
applying an adhesive layer to a surface of the first intermediate waste polymeric material sheet; and
adhering the reinforcing material to the first intermediate waste polymeric material sheet using the adhesive layer.

43. A method according to claim 39 wherein the step of forming a reinforced sheet includes:
heating the blowing agent and waste polymeric material mixture to melt the at least one non-fibrous thermoplastic material;
calendering the heated blowing agent and waste polymeric material mixture to form the first intermediate waste polymeric material sheet; and
pressing the reinforcing material and the first intermediate waste polymeric material sheet together.

44. A method according to claim 39 wherein the step of forming a reinforced sheet includes:
heating the blowing agent and waste polymeric material mixture to melt the at least one non-fibrous thermoplastic material;
extruding the heated blowing agent and waste polymeric material mixture to form a blended extrudate;
calendering the blended extrudate to form the first intermediate waste polymeric material sheet; and
pressing the reinforcing material and the first intermediate waste polymeric material sheet together.

45. A method according to claim 39 wherein the step of forming a reinforced sheet includes:
heating the blowing agent and waste polymeric material mixture to melt the at least one non-fibrous thermoplastic material;
extruding the heated blowing agent and waste polymeric material mixture through a sheet die to form the first intermediate waste polymeric material sheet; and
pressing the reinforcing material and the first intermediate waste polymeric material sheet together.

46. A method according to claim 39 wherein the step of forming a reinforced sheet includes:
heating the blowing agent and waste polymeric material mixture to melt the at least one non-fibrous thermoplastic material;
drawing the heated blowing agent and waste polymeric material mixture through a first nip between first and second calender rolls to form the first intermediate waste polymeric material sheet; and
drawing the first intermediate waste polymeric material sheet and the reinforcing material through a second nip between the second calender roll and a third calender roll.

47. A method according to claim 39 wherein the step of forming a reinforced sheet includes:
heating the blowing agent and waste polymeric material mixture to melt the at least one non-fibrous thermoplastic material;
drawing a first portion of the heated blowing agent and waste polymeric material mixture through a first nip between first and second calender rolls to form the first intermediate waste polymeric material sheet;
drawing a second portion of the heated blowing agent and waste polymeric material mixture through a second nip between third and fourth calender rolls to form a second intermediate waste polymeric material sheet; and
drawing the first and second intermediate waste polymeric material sheets and the reinforcing material through a third nip between the second calender roll and the third calender roll, the reinforcing material being positioned between the first and second intermediate waste polymeric material sheets.
